(19) United States
(12) Patent Application Publication
(10) Pub. No.: US 2014/0050214 A1
(43) Pub. Date: Feb. 20, 2014

(54) GATEWAY AND METHOD FOR ESTABLISHING VOICE COMMUNICATION OVER NETWORK USING THE GATEWAY

(71) Applicant: HON HAI PRECISION INDUSTRY CO., LTD., New Taipei (TW)

(72) Inventors: Shih-Hao TUNG, New Taipei (TW); Li-Jen HSU, New Taipei (TW); Shih-Min HU, New Taipei (TW)

(73) Assignee: HON HAI PRECISION INDUSTRY CO., LTD., New Taipei (TW)

(21) Appl. No.: 13/956,392

(22) Filed: Aug. 1, 2013

(30) Foreign Application Priority Data
Aug. 17, 2012 (TW) 101129858

(51) Int. Cl. H04L 29/06

(52) U.S. Cl. CPC H04L 65/102
USPC 370/352

(57) ABSTRACT

A gateway connects to a communication device, and communicates with a voice communication server through a network. When the communication device requests to establish a voice communication with a third-party communication terminal, the gateway parses the request to calculate a network bandwidth sufficient to establish the voice communication, and then requests the voice communication server to allocate the required network bandwidth for establishing the voice communication. Then voice data streaming sent from the communication device and the third-party communication terminal are respectively processed to generate RTP packets. The RTP packets are transmitted between the communication device and the third-party communication terminal, so as to realize the voice communication between the communication device and third-party communication terminal.

### BACKGROUND

1. Technical Field

Embodiments of the present disclosure relate to voice over Internet protocol (VOIP) communication technologies, and particularly to a gateway and a method for establishing voice communication over a network using the gateway.

2. Description of Related Art

Voice over Internet protocol (VoIP) technologies are widely used for provision of communication services over the public Internet, rather than via the public switched telephone network (PSTN). In a traditional voice communication method based on the VoIP technologies, a voice communication server provides voice communication services between different communication devices but also processes voice data of different voice communications. However, work loads of the voice communication server may be heavy with an increasing number of networks users using the voice communication services, which is prone to decrease quality of the voice communications.

### BRIEF DESCRIPTION OF THE DRAWINGS

FIG. 1 is a schematic diagram illustrating one embodiment of a gateway used to establish a communication between a communication device and a voice communication server through a network.

FIG. 2 is a schematic block diagram of the gateway of FIG. 1 including a plurality of functional modules.

FIG. 3 is a flowchart of one embodiment of a method for establishing a voice communication between the communication device and the third-communication terminal of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

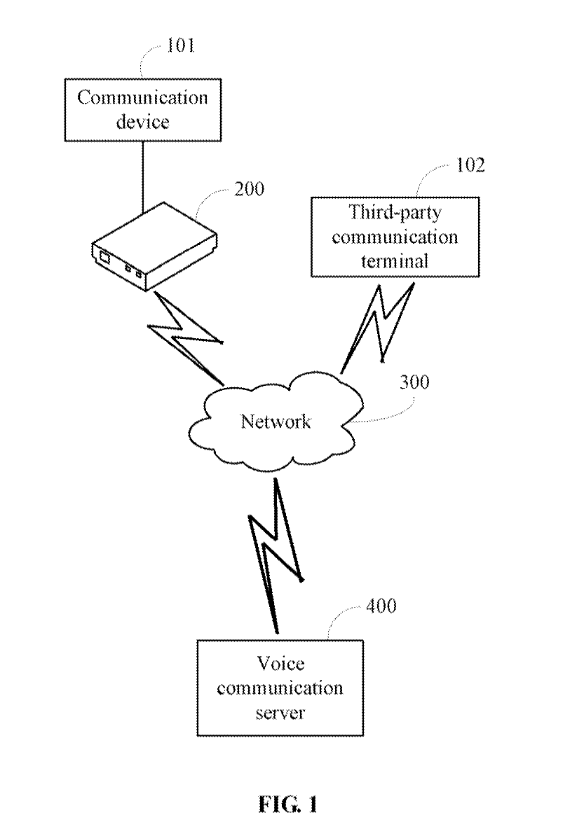

FIG. 1 is a schematic diagram illustrating one embodiment of a gateway 200 used to establish a communication between a communication device 101 and a voice communication server 400 through a network 300. In the embodiment, the voice communication server 400 provides voice communication services for the communication device 101 and one or more third-party communication terminals 102. The voice communication server 400 may, for example, be provided by a telecommunication company, such as AT&T Company or China Mobile Company (CMC).

In the embodiment, both the communication device 101 and each of the third-party terminals 102 may be various of communication device, such as a smart phone, a personal digital assistant, a fixed telephone, or other similar devices. The communication device 101 and the third-party terminals 102 can use the services provided by the voice communication server 400 to establish voice communications with each other. The voice communications are established based on voice over Internet protocol (VoIP) technologies. The network 300 may be, for example, a world interoperability for microwave access (WIMAX) network, a second generation (2G) network, or a third generation (3G) network. The gateway 200 is connected to the communication device 101 via a wired connection (e.g., a data line) or a wireless connection (e.g., BLUETOOTH® OR WIFI®). It should be understood that another gateway (not shown) can be used to connect between each third-party communication terminal 102 and the network 300.

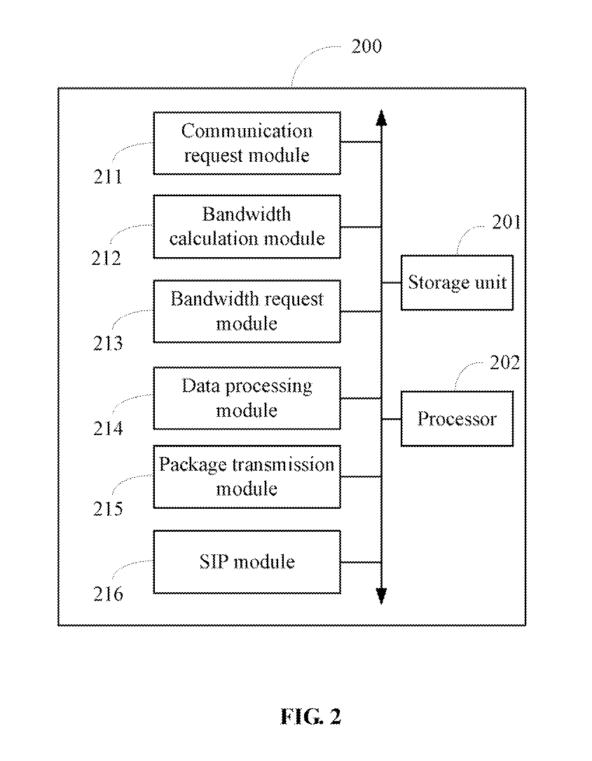

FIG. 2 is a schematic block diagram of the gateway of FIG. 1. The gateway 200 includes a storage unit 201, a processor 202, and a plurality of functional modules. Each of the functional modules may include a plurality of programs in the form of one or more computerized instructions stored in the storage unit 201 and executed by the processor 202 to perform operations of the gateway 200. In the embodiment, the plurality of modules includes a communication request module 211, a bandwidth calculation module 212, a bandwidth request module 213, a data processing module 214, a package transmission module 215, and a session initiation protocol (SIP) module 106. The processor 202 may be digital signal processing (DSP) processor.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

The communication request module 211 receives a request message sent from the communication device 101, the request message requesting to establish a voice communication with a third-party communication terminal 102. In the embodiment, the communication request module 211 may provide a user interface for the communication device 101 to login to the gateway 200. Thus, a user of the communication device 101 can send the request message to the gateway 200 via the user interface. In an example, the user interface is a webpage which includes a virtual dial keypad including a plurality of virtual buttons. A user of the communication device 1 can dial a phone number of the third-party communication terminal 102. Further, the webpage has a hypertext transfer protocol (http) address (e.g., 192.168.15.1). Thus, the user can use a browser of the communication device 101 to access to the webpage according to the http address of the webpage. The webpage may further have a software control (e.g., ActiveX) which is automatically installed in the communication device 101 at the first time when the communication device 101 logins the gateway 200. When the communication device 101 logins the gateway, the software control is activated to run by the communication request module 211, thus the communication request module 211 can receive the request message from the communication device 101 via the software control.

The bandwidth calculation module 212 extracts quality of service (QOS) parameters included in the request message, and calculates a network bandwidth (BW) sufficient to establish the voice communication between the communication device 101 and the third-party communication terminal 102 according to the extracted QOS parameters. In the embodiment, the request message includes an invite package of SIP. The invite package includes the QOS parameters, such as session description protocol (SDP) parameters and a voice codec algorithm. The SDP parameters include, for example, a regular time interval for transmission data packages (ptime) and a header length (header_len) of each data package. The voice codec algorithm may be, for example, a pulse code modulation a-law (PCMA) algorithm or a pulse code modulation u-law (PCMU) algorithm. Thus, the network bandwidth can be calculated according to the extracted parameters. For example, based on the PCMU voice codec algorithm, a formula for calculating the network bandwidth is: BW=8*(vif/8+header_len)*(1000/ptime), where vif is equal to ptime*64 bits.

The bandwidth request module 213 requests the voice communication server 400 to allocate the calculated network bandwidth for the communication device 101 to establish the voice communication with the third-party communication terminal 102. In the embodiment, the bandwidth request module 213 may send a request to the voice communication server 400 for requesting the network bandwidth at regular intervals until the network bandwidth has been allocated for the communication device 101.

When the voice communication between the communication device 101 and the third-party communication terminal 102 is established using the allocated network bandwidth, the data processing module 214 processes vocal data streaming sent from the communication device 101 to generate first real-time transport protocol (RTP) packages, and processes vocal data streaming sent from the third-party communication terminal 102 through the network 300 to generate second RTP packages, according to the voice codec algorithm included in the request message.

The package transmission module 215 transmits the first RTP packages to the third-party communication terminal 102 via the network 300, and transmits the second RTP packages to the communication device 101, thereby realizing the voice communication between the communication device 101 and the third-party communication terminal 102.

As described above, vocal data streaming of the voice communication is processed by the gateway 200 rather than by the voice communication server 400, therefore the work loads of the communication server 400 are greatly decreased, and the quality of the voice communication is improved.

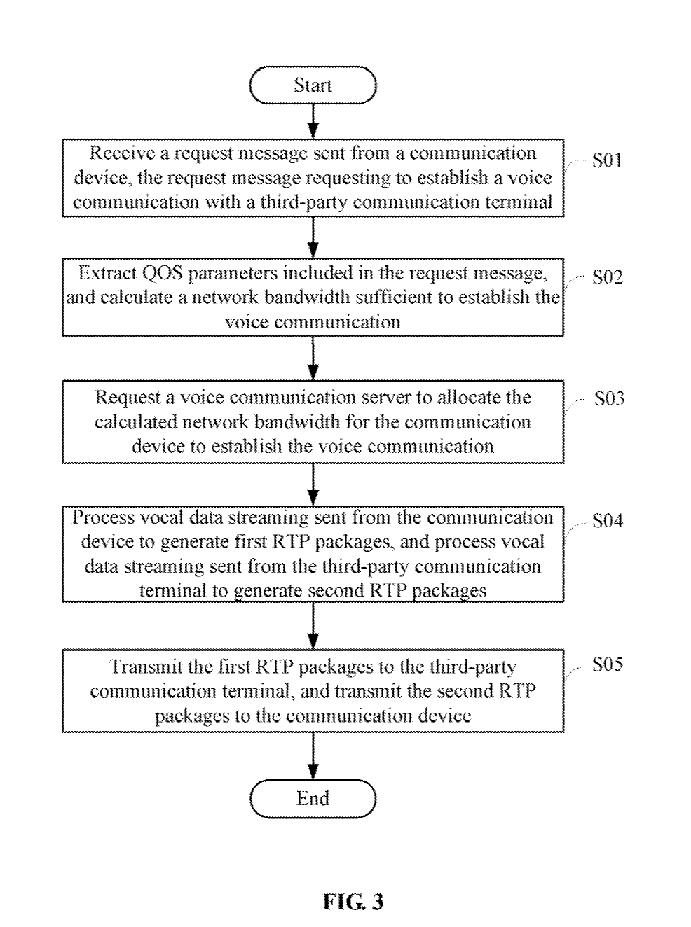

FIG. 3 shows a flowchart of one embodiment of method for establishing a voice communication between the communication device 101 and the third-communication terminal 102 of FIG. 1. Depending on the embodiment, additional steps may be added, others removed, and the ordering of the steps may be changed.

In step S01, receive a request message sent from the communication device 101 using the communication request module 211, the request message requesting to establish a voice communication with a third-party communication terminal 102.

In step S02, the bandwidth calculation module 212 extracts QOS parameters included in the request message, and calculates a network bandwidth sufficient to establish the voice communication according to the extracted QOS parameters. Details of the QOS parameters and calculation of the network bandwidth are provided in paragraph [0012].

In step S03, the bandwidth request module 213 requests the voice communication server 400 to allocate the calculated network bandwidth for the communication device 101 to establish the voice communication with the third-party communication terminal 102.

In step S04, when the voice communication between the communication device 101 and the third-party communication terminal 102 is established, the data processing module 214 processes vocal data streaming sent from the communication device 101 to generate first real-time transport protocol (RTP) packages, and processes vocal data streaming sent from the third-party communication terminal 102 through the network 300 to generate second RTP packages, according to a voice codec algorithm included in the QOS parameters of the request message.

In step S05, the package transmission module 215 transmits the first RTP packages to the third-party communication terminal 102 via the network 300, and transmits the second RTP packages to the communication device 101, thereby realizing the voice communication between the communication device 101 and the third-party communication terminal 102.

In other embodiments, the third-party communication terminal 102 can also send a voice communication request to the gateway 200 via the network 300 requesting to establish the voice communication. When the voice communication request sent from the third-party communication terminal 102 is received by the gateway 200, the SIP module 106 sends a notification to the communication device 101 to notify the user of the communication device 101 that an incoming call is received, and then processes the incoming call according to an operation of the user, such as reject or accept the incoming call. Further, if the communication device 101 has been powered off when the incoming call is received, the SIP module 106 outputs indication signals (e.g., flash light or voice message) to notify the user. Then, the SIP module 106 records reference information of the incoming call, such as a phone number or an IP address of the third-party communication terminal 102 in the storage unit 201, and sends the recorded reference information to the communication device 101 when the communication device 101 is powered on.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for establishing a voice communication using a gateway, the gateway being connected to a communication device and in communication with a voice communication terminal through a network, the method comprising:
receiving a request message sent from the communication device, the request message requesting to establish a voice communication with a third-party communication terminal;
extracting quality of service (QOS) parameters included in the request message, and calculating a network bandwidth sufficient to establish the voice communication according to the extracted QOS parameters;
requesting the voice communication server to allocate the calculated network bandwidth for the communication device to establish the voice communication;
processing vocal data streaming sent from the communication device to generate first real-time transport protocol (RTP) packages, and processing vocal data streaming sent from the third-party communication terminal through the network to generate second RTP packages, when the voice communication is established; and
transmitting the first RTP packages to the third-party communication terminal via the network, and transmitting the second RTP packages to the communication device.

2. The method according to claim 1, wherein the gateway provides a user interface for the communication device, and the communication device logins to the gateway and sends the request message to the gateway via the user interface.

3. The method according to claim 2, wherein the user interface is a webpage having a hypertext transfer protocol (http) address and a software control, the software control is automatically installed in the communication device at a first time when the communication device logins to the gateway.

4. The method according to claim 3, wherein the receiving step comprises:
activating the software control to run in the communication device; and
receiving the request message via the software control.

5. The method according to claim 1, wherein the QOS parameters comprise session description protocol (SDP) parameters and a voice codec algorithm; the SDP parameters comprises a regular time interval for transmission data packages and a header length of each data package.

6. The method according to claim 5, wherein the voice codec algorithm is a pulse code modulation a-law (PCMA) algorithm or a pulse code modulation u-law (PCMU) algorithm.

7. The method according to claim 1, wherein the requesting step comprises:
sending a request to the voice communication server for requesting the network bandwidth at regular intervals until the network bandwidth has been allocated for the communication device.

8. The method according to claim 1, further comprising:
sending a notification to the communication device to notify a user of the communication device that an incoming call is received, when the gateway receives a voice communication request sent from the third-party communication terminal.

9. The method according to claim 8, further comprising:
outputting indication signals when the voice communication request is received by the gateway upon the condition that the communication device is powered off.

10. The method according to claim 9, further comprising:
recording reference information of the incoming call in a storage unit of the gateway; and
sending the recorded reference information to the communication device when the communication device is powered on.

11. A gateway that is connected to a communication device and in communication with a voice communication server through a network, comprising:
a processor;
a storage unit;
one or more programs stored in the storage unit and executed by the processor to perform a method of:
receiving a request message sent from the communication device, the request message requesting to establish a voice communication with a third-party communication terminal;
extracting quality of service (QOS) parameters included in the request message, and calculating a network bandwidth sufficient to establish the voice communication according to the extracted QOS parameters;
requesting the voice communication server to allocate the calculated network bandwidth for the communication device to establish the voice communication;
processing vocal data streaming sent from the communication device to generate first real-time transport protocol (RTP) packages, and processing vocal data streaming sent from the third-party communication terminal through the network to generate second RTP packages, when the voice communication is established; and
transmitting the first RTP packages to the third-party communication terminal via the network, and transmitting the second RTP packages to the communication device.

12. The gateway according to claim 11, wherein the gateway provides a user interface for the communication device, and the communication device logins to the gateway and sends the request message to the gateway via the user interface.

13. The gateway according to claim 12, wherein the user interface is a webpage having a hypertext transfer protocol (http) address and a software control, the software control is automatically installed in the communication device at a first time when the communication device logins to the gateway.

14. The gateway according to claim 13, wherein the receiving step comprises:
activating the software control to run in the communication device; and
receiving the request message via the software control.

15. The gateway according to claim 11, wherein the QOS parameters comprise session description protocol (SDP) parameters and a voice codec algorithm; the SDP parameters comprises a regular time interval for transmission data packages and a header length of each data package.

16. The gateway according to claim 15, wherein the voice codec algorithm is a pulse code modulation a-law (PCMA) algorithm or a pulse code modulation u-law (PCMU) algorithm.

17. The gateway according to claim 11, wherein the requesting step comprises:
sending a request to the voice communication server for requesting the network bandwidth at regular intervals until the network bandwidth has been allocated for the communication device.

18. The gateway according to claim 11, wherein the method further comprises:
sending a notification to the communication device to notify a user of the communication device that an incoming call is received, when the gateway receives a voice communication request sent from the third-party communication terminal.

19. The gateway according to claim 18, wherein the method further comprises:
outputting indication signals when the voice communication request is received by the gateway upon the condition that the communication device is powered off.

20. The gateway according to claim 19, wherein the method further comprises:
recording reference information of the incoming call in the storage unit of the gateway; and
sending the recorded reference information to the communication device when the communication device is powered on.
